(19) United States
(12) Patent Application Publication
(10) Pub. No.: US 2014/0358623 A1
(43) Pub. Date: Dec. 4, 2014

(54) BUSINESS PROCESS MINING USING CROWDSOURCING

(71) Applicant: International Business Machines Corporation, Armonk, NY (US)

(72) Inventors: Maja Vukovic, New York, NY (US); Frederick Y. Wu, Greenwich, CT (US)

(21) Appl. No.: 13/905,482

(22) Filed: May 30, 2013

(51) Int. Cl. G06Q 10/06

(52) U.S. Cl. CPC G06Q 10/06316
USPC 705/7.26

(57) ABSTRACT

A method and system for systematically creating or improving business processes utilizing crowdsourcing. Business process steps and step connection requirements received from a plurality of experts are optimized, ordered and verified. Business process step optimization consists of eliminating invalid or obsolete business process steps received, identifying and eliminating duplicate business process steps received, and selecting most efficient business process steps. Business process steps are ordered based on the connection requirements received. Created or improved business processes are verified by a plurality of experts utilizing crowdsourcing.

### TECHNICAL FIELD

The disclosure relates generally to business process mining and more specifically to a method, computer program and computer system for utilizing crowdsourcing to create and improve business processes.

### BACKGROUND

A business process is a collection of related, structured activities or tasks that produce a specific service or product for a particular customer or customers. It often can be visualized as a sequence of activities that can be decomposed into several steps, each with their own attributes, but also contributing to achieve the goal of the process.

Traditionally, business processes are modeled or created by domain experts, business analysts and managers based on their experience and perceptions in the organization. The discovery of the individual process steps necessary (process mining) to create the business process are often found through tedious reverse engineering of the execution of the business processes based on event log reviews and holding interviews with key people. The task of business process mining is subjective and time-consuming.

Business process mining of system event logs reveals information dealing with any automated steps in the process, but not information dealing with any manual steps taken during the process, thus creating a business processes that may be out of step with the actual execution of the process. This lack of manual steps information can result in uneven and inconsistent execution of the process.

### SUMMARY

In one aspect, a method for business process mining comprises receiving a plurality of business process step definitions, discovered through a crowdsourcing engine. The plurality of business process step definitions include first business process steps, second business process steps and connection requirements. The connection requirements comprise a relationship between output requirements for the first business process steps and input requirements for the second business process steps. The method further comprises optimizing the first and the second business process steps by analyzing the plurality of business process step definitions and the connection requirements between the first business process steps and the second business process steps and validating the optimized plurality of business process steps using a verification engine.

In another aspect, a computer program product for business process mining comprises one or more computer-readable tangible storage devices and program instructions stored on at least one of the one or more computer-readable tangible storage devices. The program instructions comprise program instructions to receive a plurality of business process step definitions, discovered through a crowdsourcing engine. The plurality of business process step definitions include first business process steps, second business process steps and connection requirements. The connection requirements comprise a relationship between output requirements for the first business process steps and input requirements for the second business process steps. The program instructions further comprise program instructions to optimize the first and the second business process steps by analyzing the plurality of business process step definitions and the connection requirements between the first business process steps and the second business process steps. The program instructions further comprise program instructions to validate the optimized plurality of business process steps using a verification engine.

In another aspect, a computer system for business process mining comprises one or more processors, one or more computer-readable memories, one or more computer-readable tangible storage devices, and program instructions stored on at least one of the one or more storage devices for execution by at least one of the one or more processors via at least one of the one or more memories. The program instructions comprise program instructions to receive a plurality of business process step definitions, discovered through a crowdsourcing engine. The plurality of business process step definitions include first business process steps, second business process steps and connection requirements. The connection requirements comprise a relationship between output requirements for the first business process steps and input requirements for the second business process steps. The program instructions further comprise program instructions to optimize the first and the second business process steps by analyzing the plurality of business process step definitions and the connection requirements between the first business process steps. The program instructions further comprise program instructions to validate the optimized plurality of business process steps using a verification engine.

### BRIEF DESCRIPTION OF THE SEVERAL VIEWS OF THE DRAWINGS

FIG. 1 is a functional block diagram illustrating a data processing environment depicted in accordance with an embodiment of the present invention.

FIG. 2 is schematic block diagram which illustrates examples of game theory concepts for simultaneous and sequential verification depicted in accordance with an embodiment of the present invention.

FIG. 3 is a block diagram illustrating an example of the question template repository and process step definitions depicted in accordance with an embodiment of the present invention.

FIG. 4 is a flowchart illustrating steps performed by a Business Process Mining module (BPMM), illustrated within the data processing environment of FIG. 1, for mining business processes steps, in accordance with an embodiment of the present invention.

FIG. 5 is a flowchart illustrating steps performed by BPMM for discovering business process steps, in accordance with the embodiment shown in FIG. 4.

FIG. 6 is a schematic block diagram which illustrates internal and external components of a server computer in accordance with an illustrative embodiment.

### DETAILED DESCRIPTION

Business processes can be one of the most valuable assets of enterprises. Large enterprises continuously produce new processes to maintain industry best practices and standards, to accommodate changes in the working environment, and to reduce cost and increase efficiency. New business process design depends on the understanding of the existing business process and on the expertise and experiences of the teams that execute the business process.

Embodiments of the present invention recognize that business processes maintained by enterprises are often out of step with the actual execution of the process and need to be created, re-created or updated. Embodiments of the present invention also recognize the importance of an efficient and consistent execution of a business process across an enterprise, regardless of geography. The teams that actually execute the business process possess the expertise and experience to understand the business process, to recognize any inconsistencies in the documented business process and to be cognizant of any local customizations made to the business process. These teams are herein referred to as the “experts”. These same experts often develop and use their own automation tools or their own specialized workarounds to improve their personal efficiency or to improve the process flexibility. Experts are able to recognize unnecessary or obsolete steps in the business process that, if followed, affect the quality and efficiency of the process execution.

Embodiments of the present invention systematically discover process steps through a crowdsourcing engine to effectively engage multiple experts in the creation or update of a business process. The “crowdsourcing engine”, as used herein, may refer to an internal platform engaging experts within an enterprise or may refer to an external platform engaging any expert through the internet. The crowdsourcing engine serves as an intermediary between a task requester and experts who are participating in performing the task. Task requestors utilize the crowdsourcing engines to publish or broadcast their challenges and tasks and receive, as input, completed tasks.

Embodiments of the present invention also recognize the need for control and coordination of the experts engaged through the crowdsourcing engine as well as the input received through the crowdsourcing engine. Embodiments of the present invention systematically control and coordinate the received business process steps and the experts themselves, through the utilization of game theory concepts consisting of simultaneous and sequential games.

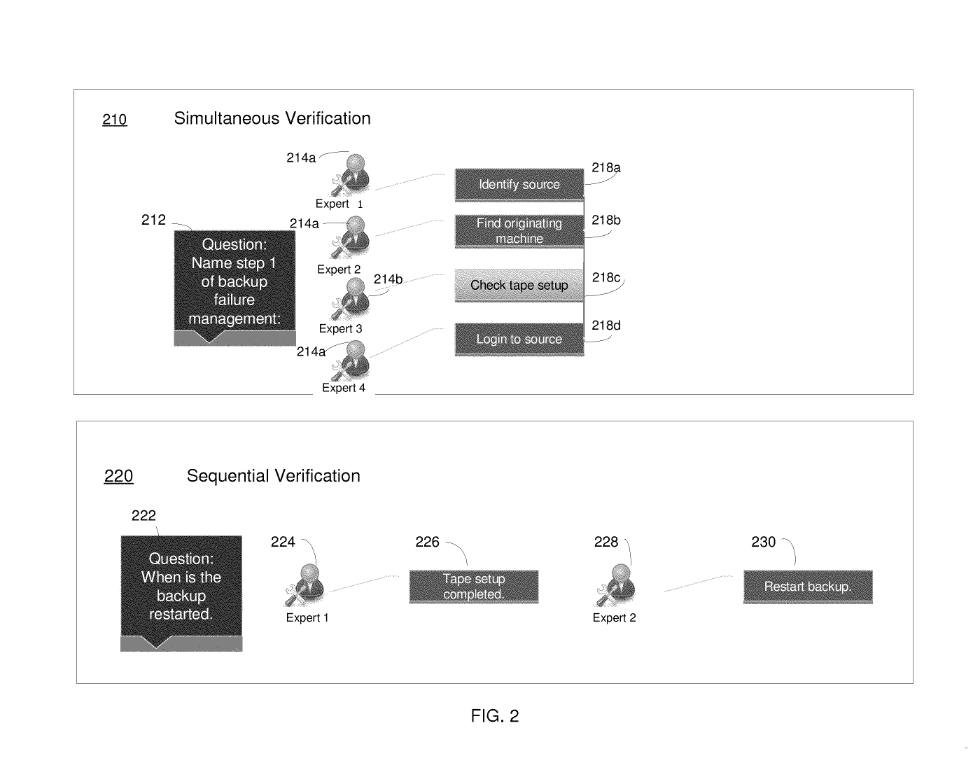

In game theory, simultaneous games are games where both players move simultaneously, or if they do not move simultaneously, the later players are unaware of the earlier players' actions (making them effectively simultaneous). Rock-Paper-Scissors, a widely played hand game, is a real life example of a simultaneous game. Both players make a decision at the same time, randomly, without prior knowledge of the opponent's decision. Embodiments of this invention utilize this concept to automate the verification and elimination, herein referred to as “pruning”, of erroneous input received from the crowdsourcing engine as well as the elimination of experts providing erroneous input. Examples of pruning using game theory's simultaneous game concepts, by embodiments of this invention, are described in FIG. 2.

Sequential games, in game theory, are games where one player chooses his action before the others choose theirs. Importantly, the later players must have some information of the first's earlier actions. For instance, a player may know that an earlier player did not perform one particular action, while he does not know which of the other available actions the first player actually performed. Sequential games are often solved by backward induction. That is, by anticipating what the last player will do in each situation, it is possible to determine what the second-to-last player will do. Games such as chess, backgammon, tic-tac-toe and Go are typical sequential games. Examples of verification using game theory's sequential game concepts, by embodiments of this invention, are described in FIG. 2.

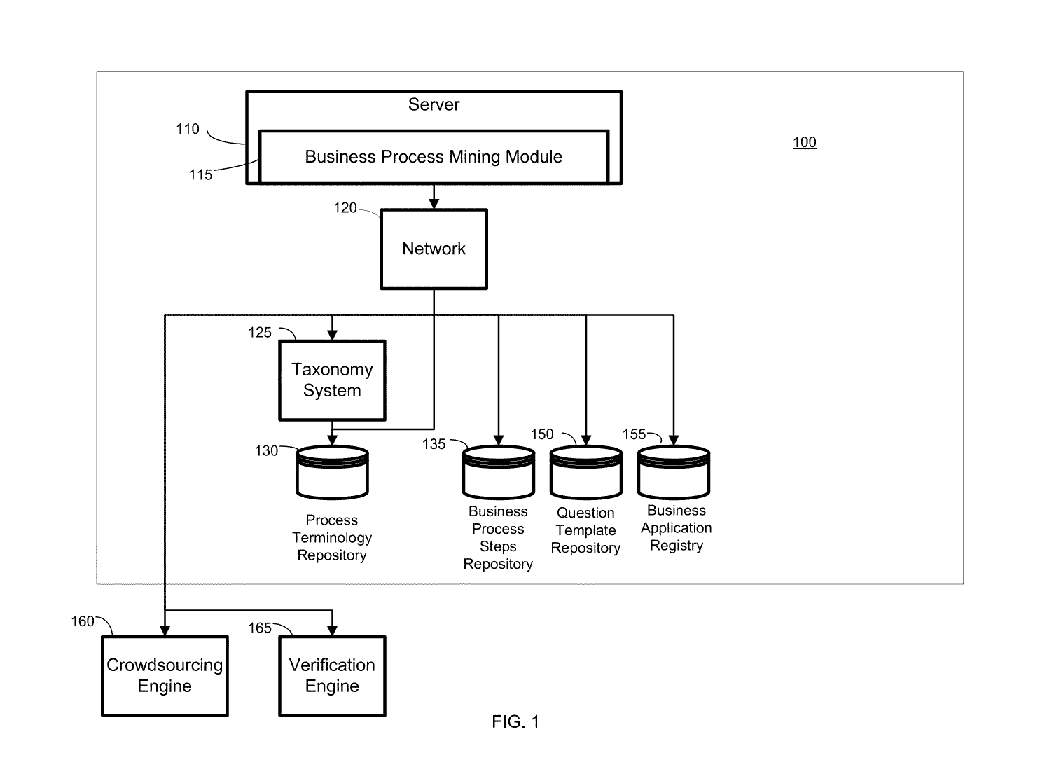

FIG. 1 illustrates a data processing system generally designated 100 in which illustrative embodiments may be implemented. Data processing system 100 contains network 120, which is the medium used to provide communication links between various data sources and computers connected together within and without data processing system 100. Network 120 may include connections, such as wire, wireless communication links, or fiber optic cables. Of course, data processing system 100 also may be implemented as a number of different types of networks, such as an intranet, a local area network (LAN), or a wide area network (WAN). FIG. 1 is intended as an example, and not as an architectural limitation for the different embodiments.

Business Process Mining module (BPMM) 115 located in data processing system 100 may be stored on one or more computer readable storage devices and may run on a server 110. BPMM 115 may be, for example, a computer program or program component for analyzing business process data, according to embodiments of the present invention. BPMM 115 may be localized on one server 110 and/or distributed between two or more servers.

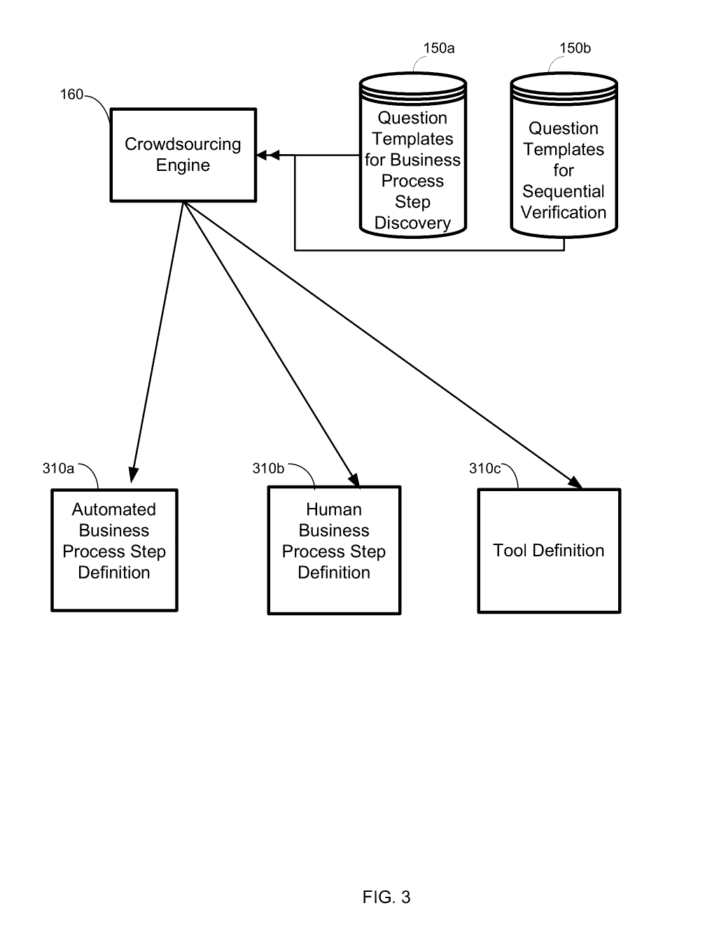

As shown in FIG. 1, the BPMM 115 connects to the crowdsourcing engine 160, through the network 120 to publish or broadcast tasks to be performed and to receive completed tasks. The BPMM 115 connects to data repositories such as, but not limited to, Process Terminology Repository 130, Business Process Steps Repository 135, Question Template Repository 150 and Business Application Registry 155. The Process Terminology Repository 130 may be comprised of official process step naming terminology or “vocabularies” to be used by a Taxonomy System 125 to recognize similarly named steps. The Business Process Steps Repository 135 may be comprised of a series of ordered activities, herein referred to as “steps,” that together comprise a business process. The steps are ordered according to their position as they relate to other steps in the Business Process Steps Repository 135. The Business Process Steps Repository 135 may be comprised of existing business process steps to be examined or may be null, if a business process does not yet exist and a new business process is to be created. The Question Template Repository 150 may be comprised of question templates to be published or broadcast as tasks to the crowdsourcing engine 160. Examples of the question templates in the Question Template Repository 150 and examples of the information returned from the crowdsourcing engine 160 are described in FIG. 3. The Business Application Registry 155 may be comprised of identified experts for known processes, known tools used within at least one business process, automation utilized in at least one business process and assets managed by the business process. In an embodiment of the present invention, the BPMM 115 may also attach to the Taxonomy System 125. The “Taxonomy System” 125, as used herein, refers to an automated means of classifying input received as a result of task completion on the crowdsourcing engine 160. The Taxonomy System 125 applies the Process Terminology Repository's 130 vocabularies to classify the received input. The Taxonomy System 125 and the Process Terminology Repository 130 may reside internal to the data processing system 100 or may be externally accessed through the network 120. A Verification Engine 165, as used herein, provides an automated means for verifying and pruning both erroneous input received from the crowdsourcing engine 160 and the experts providing that erroneous input. The Verification Engine 165 may reside internal to data processing system 100 or may be externally accessed through the network 120.

FIG. 2 illustrates examples of game theory concepts for simultaneous and sequential verification used in embodiments of this invention. Simultaneous verification 210 may be used during the discovery of business process steps. In this example, BPMM 115 publishes or broadcasts a first task 212 from the Question Template Repository 150a (shown in FIG. 3), through the crowdsourcing engine 160, to multiple experts 214a, 214b simultaneously. In this example, the first task 212 is to define the first business process step executed when delivering IT service for a failure in backup management. The definitions returned are considered valid if at least two experts agree on the same definition. When Expert3 214b returns a definition 218c that deviates from the definitions 218a,b,d returned by the other experts 214a, simultaneous verification eliminates Expert3's 214b definition 218c and may even eliminate Expert3 214b from providing any additional input.

Sequential verification 220 may be used to verify the connection requirements between steps. The process is split into two phases, the definition phase and the guessing phase. In this example, BPMM 115 publishes or broadcasts a second task 222 from the Question Template Repository 150b (shown in FIG. 3) through the crowdsourcing engine 160 to Expert1 224, who performs the second task 222 and returns a definition 226. In this example, the second task 222 is a question about the timing of a backup restart. The definition 226 returned, which in this example is “tape setup completed”, is then published or broadcast through the crowdsourcing engine 160 to Expert2 228. Expert2 228 completes the task and returns answer 230, which Expert2 228 believes to be the successor step to definition 226. In this example, Expert2 228 returns the answer “restart backup”, matching the original second task 222. Step connections are considered valid when the answer returned 230 matches the second task 222 asked by the BPMM 115.

FIG. 3 illustrates an example of the Question Template Repository 150 used in embodiments of this invention. The Question Template Repository 150 (shown in FIG. 1) comprises pre-set lists of requested information (tasks) published or broadcast to the crowdsourcing engine 160. The Question Template repository 150 may be comprised of specialized sub-sections such as, but not limited to, first question template repository 150a containing, for example, question templates used during the discovery of business process steps and second question template repository 150b containing, for example, question templates used to verify step connections. The business process step discovery questions stored within the first question template repository 150a may be comprised of, but not limited to, questions requesting step information such as name of the step, name of the predecessor step, name of the successor step, input to the named step, output of the named step, tools required for the named step, execution time for the named step, automation characteristics of the named step. Question templates from the second question template repository 150b, used to verify step connections may be comprised of, but not limited to, questions requesting successor steps and connection requirements for steps currently being verified.

Also illustrated in FIG. 3 are examples, used in embodiments of this invention, of process step definitions received as completed tasks from the crowdsourcing engine 160. The input received may be comprised of, but not limited to, automated business process step definitions 310a, human business process step definitions 310b and tool definitions 310c. The received input will herein be referred to collectively, as “process step definitions”. Automated business process step definitions 310a may be comprised of, but not limited to, automation name, purpose of the automation, interfaces to the automation, processing time, inputs to the automated process, output from the automated process, loads handled by the automated process, predecessor step name, successor step name and connection requirements for predecessor and successor steps. Human business process step definitions 310b may be comprised of, but not limited to, step name, purpose of the step, action executed by the step, execution time, exceptions to executing the step, predecessor step name, successor step name and connection requirements for predecessor and successor steps. Tool definitions 310c may be comprised of, but not limited to, tool name, purpose of the tool, interfaces to the tool (if not mechanical), limitations of the tool, exceptions to using the tool, permissions necessary for tool usage, predecessor step name, successor step name and connection requirements for predecessor and successor steps.

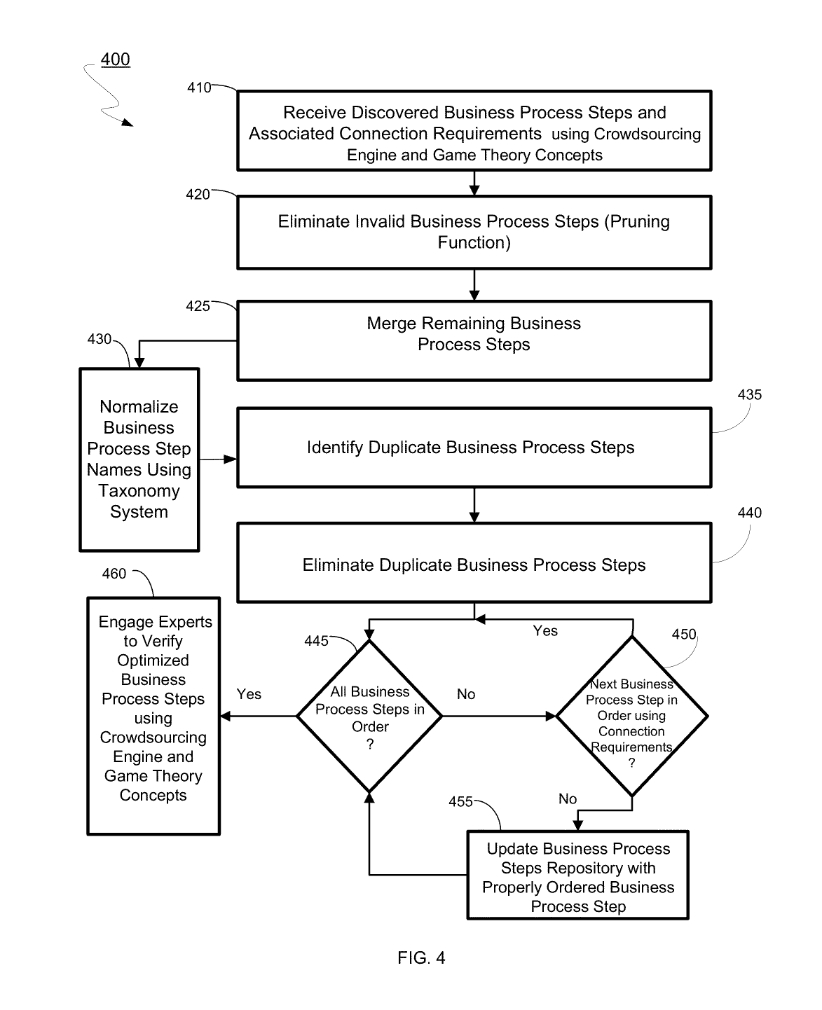

Referring to FIG. 4, a flowchart 400 illustrates steps performed by the BPMM 115, within the data processing environment of FIG. 1, for mining business processes steps, in accordance with an embodiment of the present invention. In one embodiment of the invention, a new business process is created for delivering IT service. The IT service delivery experts are executing that service without a business process in place. In this embodiment, the BPMM 115 systematically builds the business process steps, optimizing for the most efficient process steps among similar steps and standardizing the terminology for the business process.

In another embodiment of the invention, an existing business process for delivering IT service may have become out of sync with the actual IT service steps being executed by the experts and requires an update. In this embodiment, the BPMM 115 systematically updates the business process steps by eliminating unnecessary process steps, adding missing process steps, optimizing for the most efficient process steps among similar steps, and standardizing the terminology for the business process.

In both embodiments, the business process steps to be discovered consist of automation as a business process step, tools utilized by the experts and human executed business process steps. IT service delivery as a business process is only one example and does not limit the method to IT service delivery nor limit the types of business process steps to automation, tool and human executed business process steps. This method can be utilized to create business processes or update business processes for any type of service delivery such as home appliance repair or automobile maintenance as well as for non-service related business processes where at least one human execution step exists in the business process.

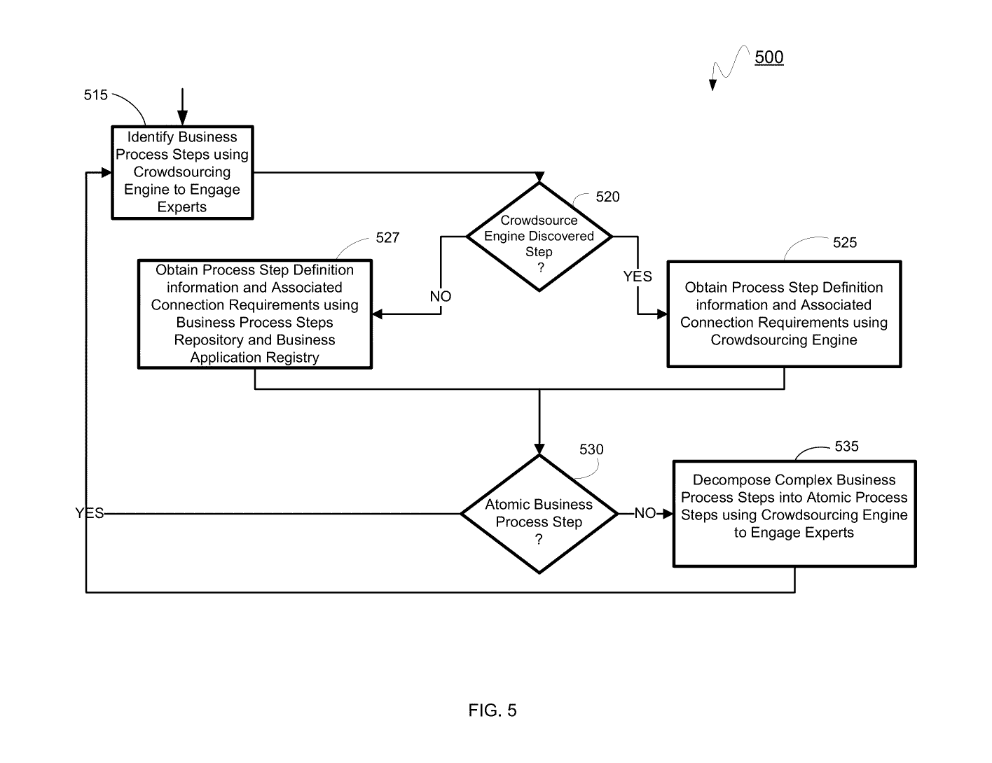

According to an embodiment of the present invention, the BPMM 115, at 410, receives the business process steps from the crowdsourcing engine 160. The received business process steps, as well as step names, step connection requirements and associated process step definitions are herein referred to as “discovered steps.” The method for discovering those steps is discussed below in connection with FIG. 5. The discovered steps' connection requirements are used for ordering the steps by identifying input requirements for the step, predecessor steps, outputs from the steps and successor steps. The process step definitions may be comprised of, but not limited to, execution time, tools required for the execution of the step, exceptions and indications of automated execution step, human executed step or tool.

Because the discovered steps received are from a potentially large group of experts, the BPMM 115, at 420, systematically verifies and prunes the discovered steps to manage both the discovered steps and the experts. This systematic verification and pruning of discovered steps may be performed, for example, by the Verification Engine 165, which may utilize any of the process step definition information for verification purposes. In both embodiments, a discovered step whose connection requirements do not match the connection requirements of its predecessor or successor steps is deemed invalid and eliminated from the set of discovered steps. The expert providing that invalid input may also be eliminated, by removal from the Business Application Registry 155, and prevented from providing any additional input. In the embodiment updating an existing business process, the BPMM 115, at 420, may additionally prune existing steps that are no longer executed and remove the obsolete steps from the Business Process Steps Repository 135. The Verification Engine 165 may use game theory concepts and simultaneous verification to prune the invalid steps and the invalid experts, as discussed above in connection with FIG. 2.

The BPMM 115, at 425, merges the remaining discovered steps since the remaining discovered steps are all determined to be valid steps. The merged steps are then normalized by the BPMM 115, at 430, through the Taxonomy System 125, to provide a consistent, standardized terminology for discovered step names. The Taxonomy System 125 accesses the Process Terminology Repository 130, determines similar step names from the “vocabulary” and returns a normalized step name for each discovered step. The normalized step names returned match the Process Terminology Repository 130 “vocabulary”. Normalized step names allow processes to be consistent across an enterprise, regardless of geography. The BPMM 115, at 435, receives the normalized step names from the Taxonomy System 125. In the embodiment creating a new business process, all steps are new to the process. The BPMM 115 adds all unique, new step names to the Process Terminology Repository 130 “vocabulary.” In the embodiment updating an existing business process, not all the steps are new. The BPMM 115 only adds those step names that are new to the process to the Process Terminology Repository 130 vocabulary.

After normalization, the merged steps may contain duplicate steps. The normalization of the step names allows for a systematic identification of duplicates steps among the merged steps. In these embodiments, duplicate names may not always indicate true duplicate steps. The process step definitions may differ for similarly named steps. Varying experts may, for example, input similarly named steps where the step definitions differ only in their step execution time. The normalization of the step names, therefore, also allows for a systematic comparison among similar steps, as in this example, to select the discovered step with the shortest execution time. The BPMM 115, at 435, identifies these duplicate steps and at 440 eliminates duplicate steps and less efficient steps from the merged steps.

Again, because the input is coming from a potentially large group of experts, the discovered steps need to be systematically managed, verified and added to the Business Process Steps Repository 135. In this example, the Business Process Steps Repository 130 being built or updated is for the IT service delivery business process.

At first decision 445, the BPMM 115 iterates with second decision 450 until all discovered steps in the merged steps are in order. The BPMM 115, at second decision 450, uses connection requirements, predecessor steps and successor steps to determine step order. In the embodiment creating a new business process, the BPMM 115, at 455, adds steps, in order, to the Business Process Steps Repository 135. In the embodiment updating an existing business process, the ordered steps may not match the existing order of the steps in the Business Process Steps Repository 135 for this business process. The BPMM 115, at 455, recognizes the existing Business Process Steps Repository 135 order and inserts unique, new steps in proper order among the existing steps in the repository, reorders existing steps in the repository when the discovered order of steps has changed and replaces steps in the repository when, for example, more efficient steps have been discovered.

In both embodiments of the invention, the ordered steps are then systematically verified by the BPMM 115, at 460, using game theory concepts and sequential verification, as discussed above in connection with FIG. 2. Question templates from the Question Template Repository 150b, that utilize the connection requirements associated with each discovered process step, are published or broadcast to the crowdsourcing engine 160 to ensure, through sequential verification, that the discovered steps are in proper order. The BPMM 115 may update the Business Application Registry 155 to add newly discovered automated step definitions or tool definitions, to remove obsolete automated step definitions or tool definitions, or modify changed automated step definitions or tool definitions.

Referring to FIG. 5, a flowchart 500 illustrates the discovery of business process steps and step definitions. The BPMM 115 may identify experts from the Business Application Registry 155 or engage unknown experts when using the crowdsourcing engine 160 to discover process steps. The BPMM 115, at 515, publishes or broadcasts question templates (tasks) from the Question Template Repository 150a, through the crowdsourcing engine 160, to multiple experts simultaneously in order to discover the next step in the process. For existing business processes that have steps already defined in the Business Process Steps Repository 135, the discovered steps will include both the existing business process steps from the Business Process Steps Repository 135 along with any business process steps identified through the crowdsourcing engine.

The BPMM 115, at 520, determines if the business process step is discovered through the crowdsourcing engine 160 or is a step in an existing business process already in the Business Process Steps Repository 135. At 525, in response to determining that the business process step is discovered through the crowdsourcing engine 160 (decision 520, yes branch), the BPMM 115 publishes or broadcasts tasks from the Question Template Repository 150a, to discover the step definition and connection requirements for a step discovered through the crowdsourcing engine 160. At 527, in response to determining that the business process step is not discovered through the crowdsourcing engine 160 (decision 520, no branch), the BPMM 115 obtains existing step definition and connection requirements from the Business Process Steps Repository 135 and the Business Application Registry 155, since the step is already defined in an existing business process.

The discovered steps may be discreet, single action business process steps, herein referred to as “atomic” steps, or complex steps comprising more than one executed action. At 530, the BPMM's 115 determination of an atomic step (decision 530, yes branch) indicates the completion of that step's discovery. Complex steps require iterative engagement with the experts to decompose the complex steps into atomic steps. The BPMM 115, at 535, publishes or broadcasts tasks to the crowdsourcing engine 160 with iterative question templates until the complex step has been completely decomposed into atomic steps with their associated step definitions and connection requirements. Until the business process for IT service delivery, in this embodiment, discovers all necessary business process steps and is complete, the BPMM 115 iterates at 515.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

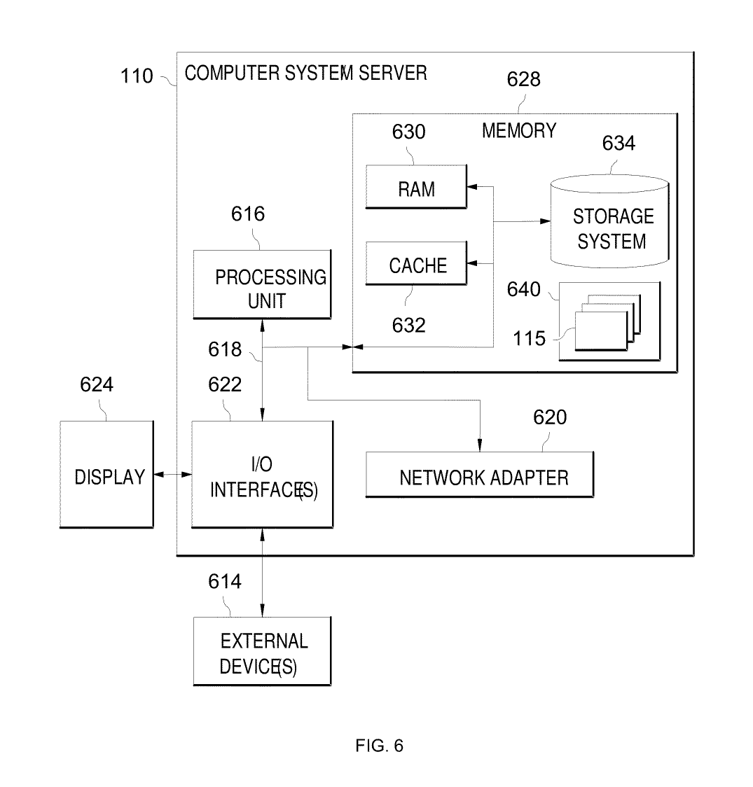

FIG. 6 illustrates internal and external components of server computer 110 in accordance with an illustrative embodiment. Server 110 is only one example of a suitable server computer and is not intended to suggest any limitation as to the scope of use or functionality of embodiments of the invention described herein. Regardless, server 110 is capable of being implemented and/or performing any of the functionality set forth hereinabove.

Server 110 is operational with numerous other general purpose or special purpose computing system environments or configurations. Examples of well-known computing systems, environments, and/or configurations that may be suitable for use with computer system/server 110 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices, and the like.

Server 110 may be described in the general context of computer system-executable instructions, such as program modules, being executed by a computer system. Generally, program modules may include routines, programs, objects, components, logic, data structures, and so on that perform particular tasks or implement particular abstract data types. Server 110 may be practiced in distributed data processing environments where tasks are performed by remote processing devices that are linked through a communications network. In a distributed data processing environment, program modules may be located in both local and remote computer system storage media including memory storage devices.

Server 110 is shown in FIG. 6 in the form of a general-purpose computing device. The components of computer system/server 110 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media.

System memory 628 can include computer system readable media in the form of volatile memory, such as random access memory (RAM) 630 and/or cache memory 632. Computer system/server 110 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 115, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 115 generally carry out the functions and/or methodologies of embodiments of the invention as described herein.

Computer system/server 110 may also communicate with one or more external devices 614 such as a keyboard, a pointing device, a display 624, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 622. Still yet, computer system/server 110 can communicate with one or more networks such as a local area network (LAN), a general wide area network (WAN), and/or a public network (e.g., the Internet) via network adapter 620. As depicted, network adapter 620 communicates with the other components of computer system/server 110 via bus 618. It should be understood that although not shown, other hardware and/or software components could be used in conjunction with computer system/server 110. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for business process mining, the method comprising:
receiving a plurality of business process step definitions, discovered through a crowdsourcing engine, the plurality of business process step definitions include first business process steps, second business process steps and connection requirements, wherein the connection requirements comprise a relationship between output requirements for the first business process steps and input requirements for the second business process steps;
optimizing the first and the second business process steps by analyzing the plurality of business process step definitions and the connection requirements between the first business process steps and the second business process steps; and
validating the optimized plurality of business process steps using a verification engine.

2. The method of claim 1, wherein optimizing the first and second business process steps comprises eliminating invalid business process steps using a pruning function.

3. The method of claim 1, wherein optimizing the first and second business process steps comprises merging the first business process steps and the second business process steps.

4. The method of claim 1, wherein optimizing the business process steps comprises identifying and eliminating one or more duplicate business process steps.

5. The method of claim 1, wherein optimizing the business process steps comprises re-ordering the first and second business process steps based on the connection requirements.

6. The method of claim 1, wherein the verification engine comprises the crowdsourcing engine.

7. The method of claim 2, wherein the pruning function uses one or more game theory techniques.

8. The method of claim 4, wherein the identifying of duplicate business process steps comprises normalizing business process step names using a taxonomy system.

9. The method of claim 6, wherein the verification engine uses one or more game theory techniques.

10. A computer program product for business process mining, the computer program product comprising one or more computer-readable tangible storage devices and program instructions stored on at least one of the one or more computer-readable tangible storage devices, the program instructions comprising:
program instructions to receive a plurality of business process step definitions, discovered through a crowdsourcing engine, wherein the plurality of business process step definitions include first business process steps, second business process steps and connection requirements, wherein the connection requirements comprise a relationship between output requirements for the first business process steps and input requirements for the second business process steps;
program instructions to optimize the first and the second business process steps by analyzing the plurality of business process step definitions and the connection requirements between the first business process steps and the second business process steps; and
program instructions to validate the optimized plurality of business process steps using a verification engine.

11. The computer program product of claim 10, wherein the program instructions to optimize the first and the second business process steps comprise program instructions to eliminate invalid business process steps using a pruning function, program instructions to merge the first business process steps and the second business process steps, program instructions to identify and eliminate one or more duplicate business process steps, and program instructions to re-order the first and second business process steps based on the connection requirements.

12. The computer program product of claim 10, wherein the program instructions to validate the optimized plurality of business process steps comprise program instructions executed by the crowdsourcing engine.

13. The computer program product of claim 11, wherein the program instructions of the pruning function comprise one or more game theory techniques.

14. The computer program product of claim 11, wherein the program instructions to identify and eliminate one or more duplicate business process steps comprise program instructions executed by a taxonomy system.

15. The computer program product of claim 12, wherein the program instructions executed by the crowdsourcing engine comprise one or more game theory techniques.

16. A computer system for business process mining, the computer system comprising one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive a plurality of business process step definitions, discovered through a crowdsourcing engine, wherein the plurality of business process step definitions include first business process steps, second business process steps and connection requirements, wherein the connection requirements comprise a relationship between output requirements for the first business process steps and input requirements for the second business process steps;
program instructions to optimize the first and the second business process steps by analyzing the plurality of business process step definitions and the connection requirements between the first business process steps and the second business process steps; and
program instructions to validate the optimized plurality of business process steps using a verification engine.

17. The computer system of claim 16, wherein the program instructions to optimize the first and the second business process steps comprise program instructions to eliminate invalid business process steps using a pruning function, program instructions to merge the first business process steps and the second business process steps, program instructions to identify and eliminate one or more duplicate business process steps and program instructions to re-order the first and second business process steps based on the connection requirements.

18. The computer system of claim 16, wherein the program instructions to validate the optimized plurality of business process steps comprise program instructions executed by the crowdsourcing engine.

19. The computer system of claim 17, wherein the program instructions executed by the crowdsourcing engine comprise one or more game theory techniques and wherein the program instructions to identify and eliminate one or more duplicate business process steps comprise program instructions executed by a taxonomy system.

20. The computer system of claim 18, wherein the program instructions executed by the crowdsourcing engine comprise one or more game theory techniques.
